(19) United States
(12) Patent Application Publication
(10) Pub. No.: US 2026/0147334 A1
(43) Pub. Date: May 28, 2026

(54) PLANT-WIDE OPTIMIZATION USING MODELS WITH ANALYTICAL GAINS

(71) Applicant: Honeywell International Inc., Charlotte, NC (US)

(72) Inventor: Chris Webb, Scottsdale, AZ (US)

(73) Assignee: Honeywell International Inc., Charlotte, NC (US)

(21) Appl. No.: 18/957,330

(22) Filed: Nov. 22, 2024

(51) Int. Cl. G05B 19/418

(52) U.S. Cl. CPC G05B 19/41885; G05B 2219/37591

(57) ABSTRACT

A method for determining an optimal operating point for a plant using a gain matrix of a flowsheet model for one or more of a plurality of manipulated variables using limits set for the at least one of the plurality of controlled variables and the plurality of manipulated variables; wherein the flowsheet model includes a plurality of models that represent a plurality of process units or routing elements in the plant, wherein each gain in the gain matrix relates a change in one of the plurality of manipulated variables to a corresponding change in one of the plurality of controlled variables, wherein each gain is generated as a product of individual, analytical gains for each process unit and routing element; and causing the at least one process controller to control the plurality of process units in accordance with the optimal operating point.

### BACKGROUND

As with most optimization techniques, a Site Wide Optimizer (SWO) uses a flowsheet model of a plant to determine the most economical or best operating point for the various process units in the plant. The type of model required varies depending on usage—dynamic models are required for control calculations whereas steady state models are required for process optimization. In particular, the SWO uses steady state gains in the flowsheet model relating changes in manipulated variables (MVs) to corresponding changes in controlled variables (CVs) in the flowsheet model. In other words, the SWO uses the gain relationships between the operating handles or manipulated variables (e.g., distillation cutpoint, reactor severity, flow routing or the like) and flow and quality properties of products and other key streams (controlled variables) in the flowsheet model.

To date, the SWO relies on numeric calculation of the process gains using a series of step tests to develop a gain matrix for the flowsheet model. Specifically, the SWO makes an incremental change in each of the operating handles (manipulated variables) and monitors how the change plays out in the controlled variables through the flowsheet model. When the stream flow and qualities have settled to their new operating point, the SWO takes the difference between the new operating point and the original operating point, divided by the magnitude of the input, to form the associated gains (gain matrix) for the flowsheet.

While the numeric method is easy to implement and understand, there are several associated shortcomings including:
1. The observed movement is dependent on the size of the input change. Too small of a move will not be observed. Too large of a move may overwhelm the operating point and lead to erroneous conditions, e.g., streams with negative flows.
2. Numerical precision can cause fluttering in the gains. That is, small changes can lead to observable differences in the gains. This, in turn, can cause the SWO to behave differently.
3. Depending on the operating state, small differences between the operating conditions leads to gains for relationships known to have no gain (a zero-gain model).
4. The size of the operating handle (manipulated variable) move must be set for every operating handle. Furthermore, only one move size is available for each handle and that must accommodate all related stream moves.

### SUMMARY

A method for plant-wide optimization is provided The method includes: receiving limits for at least one of a plurality of controlled variables and a plurality of manipulated variables for a plant at a user interface; determining an optimal operating point using a gain matrix of a flowsheet model for one or more of the plurality of manipulated variables using the limits for the at least one of the plurality of controlled variables and the plurality of manipulated variables; wherein the flowsheet model includes a plurality of models that represent a plurality of process units or routing elements in the plant, the plant comprising at least one process controller coupled to field devices of the plurality of process units, wherein each of the plurality of process units comprise equipment for converting a raw material or an intermediate material into another material; wherein the plurality of models are interconnected in the flowsheet model to create a plant-wide model with a plurality of paths between a plurality of inlets of the plant and a plurality of outlets; wherein the flowsheet model includes the plurality of manipulated variables and the plurality of controlled variables, each associated with one or more of the plurality of process units or routing elements; wherein each gain in the gain matrix relates a change in one of the plurality of manipulated variables to a corresponding change in one of the plurality of controlled variables, wherein each gain is generated as a product of individual, analytical gains for each process unit and routing element between the one of the plurality of manipulated variables and the one of the plurality of controlled variables in the flowsheet model; and causing the at least one process controller to control the plurality of process units in accordance with the optimal operating point for the one or more of the plurality of manipulated variables.

### BRIEF DESCRIPTION OF THE DRAWINGS

Embodiments of the present invention can be more easily understood and further advantages and uses thereof more readily apparent, when considered in view of the description of the preferred embodiments and the following figures in which:

FIG. 1 is a schematic diagram that illustrates one example of a flowsheet model of a physical plant that uses analytical models of elements in the physical plant to produce a gain matrix for the flow sheet model that can be used to determine an optimized operating point for the physical plant.

FIG. 2 is one embodiment of a system for plant-wide optimization using analytical models of process units in the physical plant.

FIG. 3 is a flow chart that illustrates one embodiment of a method for plant-wide optimization using a flowsheet model with a gain matrix derived from individual, analytical models of processing units corresponding to the physical plant.

FIG. 4 is a graphical depiction of a model for a splitter for use in developing a gain matrix for a flowsheet model of a physical plant.

FIG. 5 is a graphical depiction of a model for a junction for use in developing a gain matrix for a flowsheet model of a physical plant.

FIG. 6 is a graphical depiction of a model for a tank for use in developing a gain matrix for a flowsheet model of a physical plant.

FIG. 7 is a graphical depiction of a model for a tear for use in developing a gain matrix for a flowsheet model of a physical plant.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

### Definitions of Terms

As described above, a Site Wide Optimizer (SWO) uses a flowsheet model of a plant to determine the most economical or best operating point for the various process units in the plant. For optimization, the SWO uses steady state gains in the flowsheet model relating changes in manipulated variables to corresponding changes in controlled variables in the flowsheet model. In other words, the SWO uses the gain relationships between the operating handles or manipulated variables (e.g., distillation cutpoint, reactor severity, flow routing or the like) and flow and quality properties of products and other key streams (controlled variables) in the flowsheet model. As an improvement to the optimization process of the SWO, embodiments of the present invention derive the steady state gains for the plant using analytical gains for the models of the various process units in the plant.

To aid in the understanding of the embodiments of the invention, the following definitions are provided:

The term “industrial plant,” “plant,” and/or similar terms used herein interchangeably may refer to one or more buildings, complex, or arrangement of components that perform a chemical, physical, electrical, mechanical process, and/or the like for converting input materials into one or more output products. Non-limiting examples of an industrial plant include a chemical industrial plant, automotive manufacturing plant, distillery, oil refinery, fabric manufacturing plant, and/or the like.

The term “physical component,” “object,” “process module,” or “process unit” with respect to an industrial plant may refer to asset(s) within or associated with the industrial plant. Such assets, for example, may include real-world equipment, system, or other physical structure within and/or associated with the industrial plant, and that is utilized by the industrial plant. For example, a physical component with respect to an industrial plant may comprise equipment, system, or other structure that is utilized in a process performed by the industrial plant. In an example context of an oil refinery plant, non-limiting examples of a physical component may include a furnace, a pump, a heat exchanger, and/or the like.

The term “first principles model” may refer to a model-based representation of one or more processes of an industrial plant based on fundamental laws of physics, thermodynamics, kinetics, chemistry, etc. For example, a feed stream associated with a gas refrigeration plant may be defined in a first principles model in terms of its physical and/or chemical properties. As another example, a feed stream associated with a crude oil processing plant may be defined in a first principles model in terms of its physical and/or chemical properties. In some embodiments a first principles model is configured to generate model-predicted data that includes predicted values for one or more process variables associated with a process (e.g., of the industrial plant) represented in the first principles model. One or more inputs to a first principles model may be fixed input(s), while one or more inputs to the process simulation model may be variable input(s). Additionally or alternatively, one or more inputs to a first principles model may be a computed value, for example, by the first principles model and/or by a predictive model such as a machine learning model or artificial intelligent model. Additionally or alternatively, one or more inputs to the first principles model may comprise data received from the industrial plant whose process(es) is modeled by the first principles model. As a non-limiting example, such data received from an industrial plant may comprise process variable measurements (e.g., sensor-based measurements). In some examples, a first principles model may be configured for online simulation and/or offline simulation. In one or more embodiments, execution of a first principles model includes performing one or more operations. As a non-limiting example, the one or more operations may include an optimization operation with respect to one or more objective functions (e.g., minimum energy, maximum production, maximum profit, minimum cost, and/or the like) in order to determine optimal operating points/conditions for one or more output process variables. An optimal operating point/condition for an output process variable, for example, may describe a stable operating point/condition for the output process variable. In some embodiments, a first principles model may include a steady-state model or a dynamic model. For example, in some embodiments a first principles model may simulate a steady state process and/or a dynamic process. In some embodiments, a first principles model may be associated with or otherwise embodied by a digital twin model.

The term “flowsheet model” may refer to a model-based representation of one or more processes of an industrial plant. A flowsheet model may be configured to facilitate designing, developing, analyzing, monitoring, controlling, optimizing, and/or the like one or more processes of the industrial plant. Such processes for example, may include chemical processes, biological processes, and/or the like. In one or more embodiments, a flowsheet describes the process flow through an industrial plant. In a non-limiting example, a flowsheet model include a plurality of first principles models of physical components that are interconnected to model an industrial plant.

The term “controlled variable” may refer to a variable whose value is controlled to be at or near a setpoint or within a desired range, while the term “manipulated variable” may refer to a variable that is adjusted in order to alter the value of at least one controlled variable.

The term “gain” may refer to a ratio of a change in a characteristic (e.g., a flow or a property) of an output of a physical component to a change in a characteristic (e.g., a flow or a property) of an input to the physical component, wherein the change in the input caused the change to the output. For example, a petroleum processing plant may produce gasoline having octane as one characteristic or property of the gasoline. An “octane to crude gain” may be a ratio of a change in the octane property of the gasoline (output) to a change in the flow of crude into the petroleum processing plant (input). In general terms, a gain may refer to a ratio of a change in a characteristic of a controlled variable to a change in a manipulated variable. Each first principle model may include one or more gains. In one non-limiting example, each gain in a first principle model may reflect a gain between a flow of an outlet stream to a flow of an inlet stream, a property of an outlet stream to a property of an inlet stream, or a property of an outlet stream to a flow of an inlet stream.

The term “gain matrix” may refer to a matrix of real numbers, with each number representing a gain between a corresponding manipulated variable (MV)/controlled variable (CV) pair for the plant. For example, each column may represent a manipulated variable and each row may represent a controlled variable. The real number at the intersection of a particular row and column represents the gain of the controlled variable of the associated row to the manipulated variable of the associated column.

### Modeling Process Units

To overcome the shortcomings described above with the site-wide optimizer, an analytic method was developed to directly determine model gains using first principles knowledge of the flowsheet design. In this technique, a differential change is made in each of the operating handles, one at a time, and routed through the flowsheet model (network). As the change passes through a flowsheet object (process unit), it is either increased or decreased, based on the differential gain analysis of the flowsheet object, and applied to the outlet streams associated with the object. The revised differential change proceeds to the next flowsheet object until all objects have been evaluated. The resulting change becomes the steady state gain between the original handle (manipulated variable) and the final stream (controlled variable). Once all of the operating handles have been processed, the gains are stored in a gain matrix for the flowsheet model and are used by the site-wide optimizer to derive an appropriate operating point for the plant.

To implement this technique, an analytical model is derived for each object in the flowsheet model. As a more concrete example, consider a simple splitting manifold (also referred to as a “splitter” herein). In the manifold, a single stream is divided into two or more separate streams and routed to different processing units. In the SWO (and in the general), all but one of the outlet streams is under flow control and therefore impervious to inlet flow changes. The last stream is under pressure control and acts as a floating or swing stream. Consequently, the swing stream fully tracks any inlet flow change. For the swing stream, the inlet flow to outlet flow gain is 1 (fully tracking). For all other outlet streams of the splitting manifold, the gain experienced for the outlet stream is zero (invariant to changes in the inlet stream). Similarly, because the same material is propagated to all outlet streams, any change to the inlet stream properties is directly transferred to the outlet streams (the properties of the outlet stream vary based on the properties of the inlet stream). The gain matrix between inlet property to outlet property, for all outlet streams, is one.

In this splitter example, if the inlet to the splitter is from a distillation column and there is a one degree change to the cutpoint, this could result in a 120 barrel/hour increase in the flow to the splitter and ultimately to the swing stream outlet of the splitter. In this scenario, the gain in the flow from the cutpoint to the inlet of splitter can be represented as follows:

$${G}_{Dist} = \frac{120 \frac{bbl}{hr}}{1 °} = 120 \frac{bbl}{hr} / deg$$

Gain from splitter inlet to splitter outlets:

$${G}_{Swing} = 1$$

$${G}_{NotSwing} = 0$$

Overall gain from cutpoint to splitter outlets:

$${G}_{1} = {G}_{Dist} \times {G}_{Swing} = 120 \times 1 = 120$$

$${G}_{2} = {G}_{Dist} \times {G}_{NotSwing} = 120 \times 0 = 0$$

The splitter outlets will be connected to downstream units allowing the original cutpoint change to be propagated to these units. Ultimately, the flowsheet model uses the gain matrix to propagate changes in an input, such as the cutpoint change, to determine the effect on any stream in our flowsheet model.

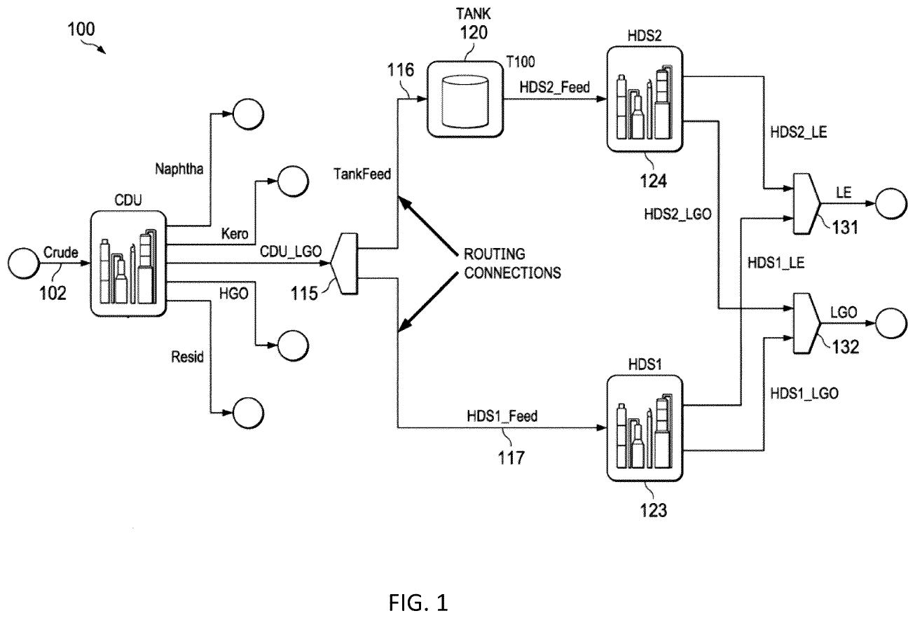

Embodiments of the present invention can be applied to a variety of types of industrial plants. By way of example and not by way of limitation, FIG. 1 shows a flowsheet model 100 for a crude oil distillation plant. The plant includes a crude oil distillation unit (CDU) coupled to two parallel hydrotreaters, according to an example aspect. Crude oil is known to be a multi-component mixture including more than 100 different compounds. Petroleum refining or distilling refers to the separation as well as reactive processes (hydrotreaters in this scenario) to yield various commercially valuable products.

The plant includes a supply of crude oil shown as crude oil (crude) 102 that is fed to a crude distillation unit (CDU) process unit. FIG. 1 for simplicity shows only an icon representing a process unit. However, the CDU process unit is represented by a model in the flowsheet model relating changes in operating conditions to output material flows and qualities of the process. Primary crude oil cuts in a typical refinery include gases, light/heavy naphtha, kerosene, light gas oil, heavy gas oil and residue. From these intermediate refinery product streams the CDU process generates several final product streams such as fuel gas, liquefied petroleum gas (LPG), gasoline, jet fuel, kerosene, auto diesel, lubricants, bunker oil, asphalt and coke. Actually, the CDU produces a number of intermediate streams which will eventually become the products listed, but only after further processing. For simplicity in this example, the intermediate product streams are labelled as being products.

The CDU process unit is shown outputting five different outputs, shown as Naphtha, Kero which is short for kerosene, heavy gas oil (HGO), light gas oil (labelled as CDU_LGO to distinguish from LGO shown later in the flowsheet), and residue shown as ‘Resid.’ Typical operating conditions for the CDU process unit may be a temperature at the entrance of the furnace where the crude 102 enters is 200 to 280° C., where the crude 102 is then further heated to about 330 to 370° C. inside the furnace. The pressure may be maintained is about 1 bar. The CDU_LGO is shown provided to a stream splitter 115. Alternatively, the CDU_LGO stream is split in two by the stream splitter 115, which provides a first portion the CDU_LGO as a tank feed 116 routing connection to the tank 120 and a second portion of the CDU_LGO as a hydrodesulfurization (also known as a hydrotreater or HDS) HDS1_feed 117 routing connection to the HDS1 unit 123. The tank 120 provides HDS_2 feed to the HDS2 unit 124. The HDS units each have a model representation as does the splitter 115 and the tank 120 as described in more detail below.

An HDS unit in the petroleum refining industry is also often referred to as a hydrotreater. Hydrodesulfurization is a catalytic chemical process widely used to remove sulfur (S) from natural gas and from refined petroleum products, such as gasoline or petrol, jet fuel, kerosene, diesel fuel, and fuel oils. The purpose of removing the sulfur, and creating products such as ultra-low-sulfur diesel, is to reduce the sulfur dioxide (SO₂) emissions that result from using those fuels in automotive vehicles, aircraft, railroad locomotives, ships, gas or oil burning power plants, residential and industrial furnaces, and other forms of fuel combustion.

The HDS1 and HDS2 units are both shown outputting light end, HDS1_LE and HDS2_LE, respectively, as well as light gas oil, HDS1_LGO and HDS2_LGO, respectively, commingling their respective streams via junctions 131 and 132. A junction is a mixing element whereby two or more streams are commingled. Junctions 131 and 132 are included, with junction 131 shown receiving HDS 2_LE and HDS1_LE and outputting light ends (LE), and junction 132 HDS1 and HDS2 outputting light gas oil (LGO). The inputs to the junctions 131 and 132 provide all their routing connections. Every line shown in this diagram in FIG. 1 represents a routing connection. Models for the junctions 131, 132 are described in more detail below.

### Models of Example Process Units or Objects

To create a gain matrix for a flow sheet model of plant 100 according to the teachings of the present invention, each processing unit is separately modeled with an analytical model. As each flowsheet logic has different properties, different gain rules are required based on the object type. In general, each object type has one or more inlets and one or more outlets. Each inlet receives a flow, such as a flow of material. The flow also has one or more properties. The object is modeled in terms of one or more gains. These gains can include a gain that equals a ratio of an outlet flow to an inlet flow, a gain that equals a ratio of a property of an outlet flow divided by a property of an inlet flow, or gain that equals a ratio of a property of an outlet flow and an inlet flow. The following are the rules or analytical models developed for a plethora of object types that can be included in a flowsheet model of a physical plant.

### Process Unit

The process unit flowsheet object represents a single process unit within a plant. The development of the relationships between the material flows into the unit and those out of the unit are beyond the flowsheet. However, these relationships are captured and expressed in the dynamic model used to control the unit. The SWO reads this dynamic model and directly employs the steady state gains associated with the model. Consequently, we can not only relate changes in the feed stocks to the outlet streams but also changes to other operating parameters. In general,

$${G}_{ProcUnt} = G$$

where G is determined outside SWO and provided by a user for use in the flowsheet model. As described above, the model for a process unit will have a number of gains between the number of inlets and outlets of the process unit with each gain relating a change in a flow or property at an outlet to a change in a flow or property at an inlet. In some embodiments, there are other, non-stream related, parameters (MVs) that may affect the operation of a unit, e.g. chemical conversion or fractionation cutpoints. These operating parameters, in turn, affect the flow and properties of the outlet stream. The gain matrix, G, for the process unit will have other columns for MVs that relate to other parameters, e.g., severity, cutpoints, or other routing objects that are not stream related. Through optimization, the SWO determines the best settings for these parameters (MVs).

### Splitter

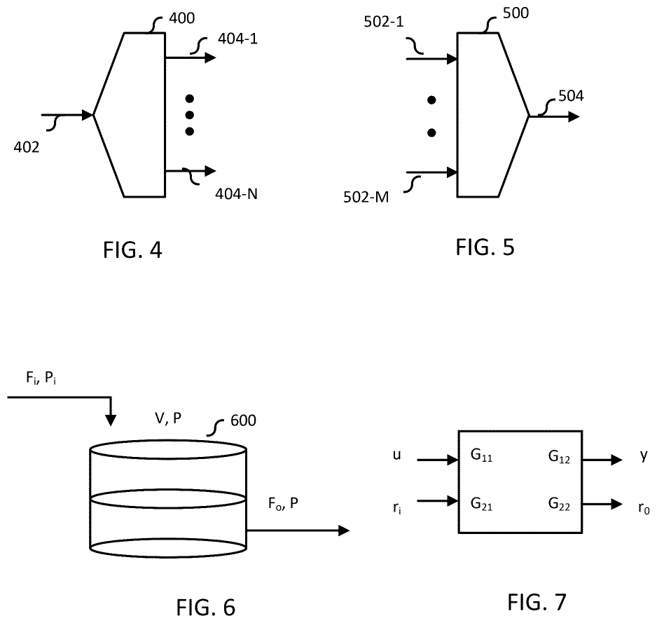

As described above and depicted in FIG. 4, a splitter 400 divides a single inlet stream 402 into multiple outlet streams 404-1 to 404-N. Depending on whether the outlet stream 404-1 to 404-N is under flow or pressure control determines whether flow changes at inlet stream 402 affect that outlet stream 401-1 to 401-N. In one embodiment, the model used for splitter 400 are:

For the Swing stream:

$${G}_{Flow} = 1$$

$${G}_{Prop} = 1$$

For the non-swing stream

$${G}_{Flow} = 0$$

$${G}_{Prop} = 1$$

### Selector

A selector is a specialized splitter in which all inlet material is diverted to a single outlet stream. If the outlet is the diversion stream, it is modeled the same as the swing stream, even though the diversion stream is not under pressure control. For the non-diversion streams, there is no material flow. However, for simplicity, we assume that the properties of the non-diversion stream still track the inlet flow. The model used are:

For the diversion stream:

$${G}_{Flow} = 1$$

$${G}_{Prop} = 1$$

For the non-diversion stream:

$${G}_{Flow} = 0$$

$${G}_{Prop} = 1$$

### Junction

FIG. 5 is a graphical depiction of a model for a junction 500 for use in developing a gain matrix for a flowsheet model of a physical plant. Junction 500 is effectively the reverse of a splitter. Junction 500 is a flow manifold in which multiple inlet streams, 502-1 to 502-M are combined into a single outlet stream 504. A change in the flow of any of the inlet streams 502-1 to 502-M directly affects the flow of outlet stream 504. Furthermore, a “mixing rule” is employed to determine the properties of the outlet stream 504.

For junction 500, the simple, linear mixing rule is employed. It calculates the properties (P) of outlet stream 504 as the flow weighted average of the properties of the inlet streams 502-1 to 502-M. Mathematically,

$$F = \sum {F}_{i}$$

$$P = \frac{\sum {F}_{i} {P}_{i}}{F}$$

where Fi and Pi are the flowrate and property, respectively of each inlet stream 502-1 to 502-M and F and P are the flowrate and properties of the outlet stream 504.

For this mixing model, we note that properties (P) of outlet stream 504 are dependent on both the properties and the flows of inlet streams 502-1 to 502-M. Therefore, there are separate gains for inlet flow to outlet property and for inlet property to outlet property. The same is not true for the flow of outlet stream 504; that is, the flow of outlet stream 504 is not dependent on the properties of the inlet stream, only the flows of the inlet streams 502-1 to 502-M. For every inlet stream of junction 500, the gain is:

$${G}_{InletFlowToOutletFlow} = 1$$

$${G}_{InletFlowToOutletProp} = \frac{( {P}_{i} - P )}{F}$$

$${G}_{InletPropToOutletProp} = \frac{{F}_{i}}{F}$$

It is noted that the outlet property is a flow weighted average and is equal to the sum of the inlet properties multiplied by their respective flowrates divided by the total flow (e.g., the outlet flow). The impact of a change in one of the inlet properties is proportional to the amount of the flow associated with the stream relative to the overall flow. In mathematical terms, the derivative of the outlet property to the inlet property equals the inlet flow divided by the outlet flow as expressed above.

### Blender

In flowsheet model, a blender is a specialized junction employing a nonlinear mix rule. Because the nonlinear mixing model is custom to the site and because different rules can be used for different properties, the computation of the gain is inherently left to the end user to develop. SWO takes the user supplied property gains and incorporates into the rest of the flowsheet. In one embodiment, the gains may be derived as follows:

$$F = \sum {F}_{i}$$

$$P = f ( {F}_{i} , {P}_{i} )$$

$$Yielding :$$

$${G}_{InletFlowToOutletFlow} = 1$$

$${G}_{InletFlowToOutletProp} = \frac{df ( {F}_{i} , {P}_{i} )}{{dF}_{i}}$$

$${G}_{InletFlowToOutletProp} = \frac{df ( {F}_{i} , {P}_{i} )}{{dP}_{i}}$$

### Tank

FIG. 6 is a graphical depiction of a model for a tank 600 for use in developing a gain matrix for a flowsheet model of a physical plant. A tank is a holding vessel acting as a flow buffer between upstream and downstream operation. Unlike other flowsheet objects, a tank object is not stateless, i.e. the properties of the outlet stream, including response time, depend on the volume and quality of the material currently stored in the tank. Derivatives of the tank properties with respect to incoming flows can only be estimated as they depend on the current tank properties, tank holdup, and the anticipated changes to the incoming stream properties. Below are six methods to estimate the derivatives (gains) for a tank.

Common to all methods is the basic operation of a tank. One or more streams with possibly varying properties and flows enter a vessel with a starting holdup with differing properties. In SWO, we treat the tank object as a “perfectly mixed” or “continuously stirred” vessel. Using this assumption, we model the outlet tank properties to be equal to the properties presently in the tank. As these properties change, so will the outlet stream properties.

Furthermore, the change in the volume of material in the tank is a function of the difference between the inlet and outlet flows multiplied by the length of time the imbalance persists. Further, to model the volume, we select a point in time (in the future) for which we are evaluating the tank.

Using material balances, we can calculate a linear mixing rule:

$$V ( t + Δ t ) = V ( t ) + ( {F}_{i} - {F}_{o} ) \times Δ t$$

$$P ( t + Δ t ) = \frac{\frac{V ( t )}{Δ t} P ( t ) + {F}_{i} {P}_{i}}{\frac{V ( t )}{Δ t} + {F}_{i}}$$

where Fᵢ and Fₒ are the inlet and outlet stream flows and Δt is the time to the optimization horizon.

When modeling tank 600, using the above equations, the incoming material is added to the material in tank 600, the material in tank 600 is mixed, and then material is removed from the tank 600 through the outlet. Consequently, Fₒ does not have a direct impact on the tank properties. Rather, it indirectly affects the properties through its impact on the volume of material in tank 600.

### Method 1—Infinite Horizon

With this method, we assume the steady state horizon is infinite. Over a long period of time, the tank properties mirror those of the inlet stream. Consequently,

$$\frac{dP}{{dF}_{i}} = 0 , \frac{dP}{{dF}_{o}} = 0$$

$$\frac{dP}{{dP}_{i}} = 1$$

This method effectively eliminates the tank from steady state flowsheet calculations. Advantageously, this method requires no calculation and is fairly simple. Unfortunately, the method does not provide a realistic model in some circumstances, especially for large tanks, e.g. component tanks.

### Method 2—Linear Approximate

With this method, the model sets the time to the optimization horizon, a user selectable parameter. Let Δt be the time to horizon. Assuming inlet flow and properties are constant then,

$$P ( t + Δ t ) = \frac{( P ( t ) V ( t ) + {P}_{i} ( t ) {F}_{i} Δ t )}{( V ( t ) + {F}_{i} ( t ) Δ t )}$$

Using the above model, we can generate:

$${G}_{InletFlowToVolume} = Δ t$$

$${G}_{OutletFlowToVolume} = - Δ t$$

$${G}_{InletFlowToTankProp} = \frac{( {P}_{i} - P ( t + Δ t ) )}{\frac{V ( t )}{Δ t} + {F}_{i}}$$

$${G}_{InletPropToTankProp} = \frac{{F}_{i}}{\frac{V ( t )}{Δ t} + {F}_{i}}$$

$${G}_{TankPropToOutletProp} = 1$$

which could also be represented as:

$$\frac{dP}{{dF}_{i}} = \frac{{P}_{i} ( t ) - P ( t + Δ t )}{( \frac{V ( t )}{Δ t} + {F}_{i} ( t ) )}$$

$$\frac{dP}{{dF}_{o}} = 0$$

$$\frac{dP}{{dP}_{i}} = \frac{{F}_{i} ( t )}{( \frac{V ( t )}{Δ t} + {F}_{i} ( t ) )}$$

This method has the advantage of being straightforward and simple. However, the model only accounts for current operating conditions.

The above equations are not exclusive. Other assumptions can be used for the tank to generate different gains.

### Method 3—Linear Approximate at Horizon

When the inlet and outlet flows and/or properties are changing, it may be better to use the projected flowrates at the end of the horizon instead of their current values. This yields:

$$V ( t + Δ t ) = V ( t ) + ( {F}_{i} ( t ) - {F}_{o} ( t ) ) \times Δ t$$

$$\frac{dP}{{dF}_{i}} = \frac{{P}_{i} ( t + Δ t ) - P ( t + Δ t )}{( \frac{V ( t + Δ t )}{Δ t} + {F}_{i} ( t + Δ t ) )}$$

$$\frac{dP}{{dF}_{o}} = 0$$

$$\frac{dP}{{dP}_{i}} = \frac{{F}_{i} ( t + Δ t )}{( \frac{V ( t + Δ t )}{Δ t} + {F}_{i} ( t + Δ t ) )}$$

This method has the advantage of being straightforward. Further, the horizon conditions may change less than current operating conditions. However, by focusing solely on conditions at the horizon, the model ignores the path to the conditions at the horizon which could affect the accuracy of the model.

### Method 4—Linear Approximate Using Unforced Model Prediction

When the inlet flows and properties vary because of upstream changes, they get reflected in the unforced model predictions (UFP). In particular, the tank volume reflects the integration of changes going from the current time through to the horizon. Starting with the basic volume equation

$$V ( t + Δ t ) = V ( t ) + ( {F}_{i} ( t ) - {F}_{o} ( t ) ) \times Δ t$$

$$or$$

$$V ( t + Δ t ) + {F}_{o} \times Δ t = V ( t ) + {F}_{i} ( t ) \times Δ t$$

We can replace the conditions at horizon with the unforced model prediction, VUFP and PUFP. So,

$$\frac{dP}{{dF}_{i}} = \frac{{P}_{i} ( t ) - {P}_{UFP}}{( \frac{{V}_{UFP}}{Δ t} + {F}_{o} ( t ) )}$$

$$\frac{dP}{{dF}_{o}} = 0$$

$$\frac{dP}{{dP}_{i}} = \frac{{F}_{i} ( t )}{( \frac{{V}_{UFP}}{Δ t} + {F}_{o} ( t ) )}$$

Alternatively, we can replace the current flows and properties with their unforced predictions yielding:

$$\frac{dP}{{dF}_{i}} = \frac{{P}_{{i}_{UFP}} - {P}_{UFP}}{( \frac{{V}_{UFP}}{Δ t} + {F}_{{o}_{UFP}} )}$$

$$\frac{dP}{{dF}_{o}} = 0$$

$$\frac{dP}{{dP}_{i}} = \frac{{F}_{{i}_{UFP}}}{( \frac{{V}_{UFP}}{Δ t} + {F}_{{o}_{UFP}} )}$$

Advantageously, this method attempts to capture anticipated upstream changes. However, to do so, the method mixes current and UFP conditions.

### Method 5—Incremental Approximate

The previous methods do not account for the impact of the outlet flow on volume, especially as we integrate out to the horizon. Considering this affect, the volume and properties of the tank can be modeled as:

$$V ( t + dt ) = V ( t ) + ( {F}_{i} ( t ) - {F}_{o} ( t ) ) \times dt$$

$$P ( t + dt ) = \frac{( P ( t ) V ( t ) + {P}_{i} ( t ) {F}_{i} dt )}{( V ( t ) + {F}_{i} ( t ) dt )}$$

Where dt is for one interval and not the whole horizon. Using these equations,

$$\frac{dV ( t + dt )}{{dF}_{i}} = \frac{dV ( t )}{{dF}_{i}} + dt$$

$$\frac{dV ( t + dt )}{{dF}_{o}} = \frac{dV ( t )}{{dF}_{o}} - dt$$

$$\frac{dV ( 0 )}{{dF}_{i}} = \frac{dV ( 0 )}{{dF}_{o}} = 0$$

$$\frac{dP ( t + dt )}{{dF}_{i}} = \frac{P ( t ) \frac{dV ( t )}{{dF}_{i}} + V ( t ) \frac{dP ( t )}{{dF}_{i}} + {P}_{i} ( t ) dt - P ( t + dt ) \times ( \frac{dV ( t )}{{dF}_{i}} + dt )}{V ( t ) + {F}_{i} dt}$$

$$\frac{dP ( t + dt )}{{dF}_{o}} = \frac{P ( t ) \frac{dV ( t )}{{dF}_{o}} + V ( t ) \frac{dP ( t )}{{dF}_{o}} - P ( t + dt ) \frac{dV ( t )}{{dF}_{o}}}{V ( t ) + {F}_{i} dt}$$

$$\frac{dP ( t + dt )}{{dP}_{i}} = \frac{V ( t ) \frac{dP ( t )}{{dP}_{i}} + {F}_{i} ( t ) dt}{V ( t ) + {F}_{i} dt}$$

$$\frac{dP ( 0 )}{{dF}_{i}} = \frac{dP ( 0 )}{{dF}_{o}} = \frac{dP ( 0 )}{{dP}_{i}} = 0$$

By looping through the above calculations, the derivatives at the end of the optimization horizon can be estimated.

This method has the advantage that it most closely captures how a step change is calculated and produces model gains closest to step gains. Also, this is the only method for which the tank outlet flow has an effect on the model gains, albeit small.

However, this method uses a recursive approach which is more complex. The added complexity may not be justified due to the small impact of including the tank outlet flow in determining the gains.

### Method 6—Nonlinear Tank Blending

In a final exemplary method, the model is based on a nonlinear mixing rule for determining the properties of the material in the tank. Under these circumstances, the nonlinear mixing rules calculates the gradients for both flow and property of material received at the inlet. Over the optimization horizon, this can be captured in the following equations:

$$P ( t + Δ t ) = f ( {F}_{i} ( t ) \times Δ t , {P}_{i} ( t ) , V ( t ) , P ( t ) )$$

$$\frac{dP}{{dF}_{i}} = \frac{d ( f ( {F}_{i} ( t ) \times Δ t , {P}_{i} ( t ) , V ( t ) , P ( t ) ) )}{{dF}_{i}}$$

$$\frac{dP}{{dP}_{i}} = \frac{d ( f ( {F}_{i} ( t ) \times Δ t , {P}_{i} ( t ) , V ( t ) , P ( t ) ) )}{{dP}_{i}}$$

As with the linear rules, we can substitute the unforced model prediction for the current operating parameters.

$$P ( t + Δ t ) = f ( {F}_{{i}_{USB}} \times Δ t , {P}_{{i}_{USB}} , {V}_{USB} , {P}_{USB} )$$

$$\frac{dP}{{dF}_{i}} = \frac{d ( f ( {F}_{{i}_{UFP}} \times Δ t , {P}_{{i}_{UFP}} , {V}_{UFP} , {P}_{UFP} ) )}{{dF}_{i}}$$

$$\frac{dP}{{dP}_{i}} = \frac{d ( f ( {F}_{{i}_{UFP}} \times Δ t , {P}_{{i}_{UFP}} , {V}_{UFP} , {P}_{UFP} ) )}{{dP}_{i}}$$

Although this method has the advantage of using a mixing rules, it places a burden of developing an appropriate mixing rule. This method uses derivatives calculated for both inlet flow change and inlet property change. And, thus there are some limitations on the scope of blending rules supported by this method.

### Tear

Tear streams are the flowsheet object used to represent recycle streams in a plant. With these streams, material from a downstream unit is returned to a upstream unit where it is reprocessed or recycled. Because recycle flows are problematic in flowsheets, the stream is “torn” into two pieces. The upstream stream represents the flow and quality at a previous instance. The tear is executed through the flowsheet and sets the downstream conditions. The upstream is then reset to the downstream conditions and the flowsheet processed again.

To find the gains of recycle lines, we employ system theory to the problem. Consider a generic system composing of two input streams, two output streams, and a transfer matrix, illustrated in FIG. 7, between them. In equation form, the gain matrix is represented as:

$$y = {G}_{11} u + {G}_{12} {r}_{i}$$

$${r}_{0} = {G}_{21} u + {G}_{22} {r}_{i}$$

| | |
|---|---|
| u | Represents an exogenous change to flowsheet, e.g. a |
| | raw material feed or cutpoint change |
| rᵢ | Tear inlet stream. This is the “upstream” stream for recycle tear |
| y | Represents output, not-recycled stream, e.g. a product stream |
| rₒ | Tear outlet stream. This is the “downstream” stream |
| | for the recycle tear |
| G11 | Gain matrix between exogenous input and output stream |
| G12 | Gain matrix between tear input and output stream |
| G21 | Gain matrix between exogenous input and tear output stream |
| G22 | Gain matrix between tear input and tear output stream |

Note that in the above formulation, the gain matrices are calculated when the recycle stream is torn so tear inlet is independent of tear outlet. Furthermore, the steady state gains are the cumulative gains between the point where the tear stream enters the flowsheet and where it exits. They typically result from the product of the steady state gains from more than one flowsheet object.

When we close the tear stream, rᵢ=rₒ. Using this knowledge, we can replace both sides of the tear stream with a single “r” representing the full recycle stream. Mathematically,

$$r = {G}_{21} u + {G}_{22} r$$

$$r = {( I - {G}_{22} )}^{- 1} {G}_{21} u$$

$$y = [ {G}_{11} + {{G}_{12} ( I - {G}_{22} )}^{- 1} {G}_{21} ] u$$

So, to calculate the gains with the recycle closed, the following procedure is used:
1. With recycle stream “torn”, make differential change to tear inlet. Capture the steady state gains associated with the outlet recycle stream, G₂₂, and, optionally, with the product stream(s), G₂₁.
   Note, the analysis must include both inlet flow changes and inlet property changes. Furthermore, the capture outlet changes should include both flow and property changes.
2. Compute inversion matrix (I−G₂₂)⁻¹
3. With the recycle stream is torn, make differential change to exogenous input (i.e. one of SWO's manipulated variables). This may be the result of an upstream stream change, e.g., raw material flow, or from an operating handle change, e.g. reactor severity. Record the steady state change in the recycle flow and properties, G₂₁.
4. Set the tear inlet stream differential to the product (I−G₂₂)⁻¹G₂₁.
5. Repeat step 3.
6. Verify the differential change in the tear outlet stream matches the inlet stream, i.e. there is consistency between inlet and outlet streams.
7. The steady state gains recorded in step 5 are the overall steady state gains when the recycle stream is closed.
8. Repeat steps 3-7 for the remaining exogenous inputs.

As an alternative to steps 4 and 5, we can directly calculate the closed-recycle steady state gains using y to u equation above. However, by including steps 4 and 5, we also determine the closed looped steady state gain for all steams downstream of the recycle outlet.

### System Example

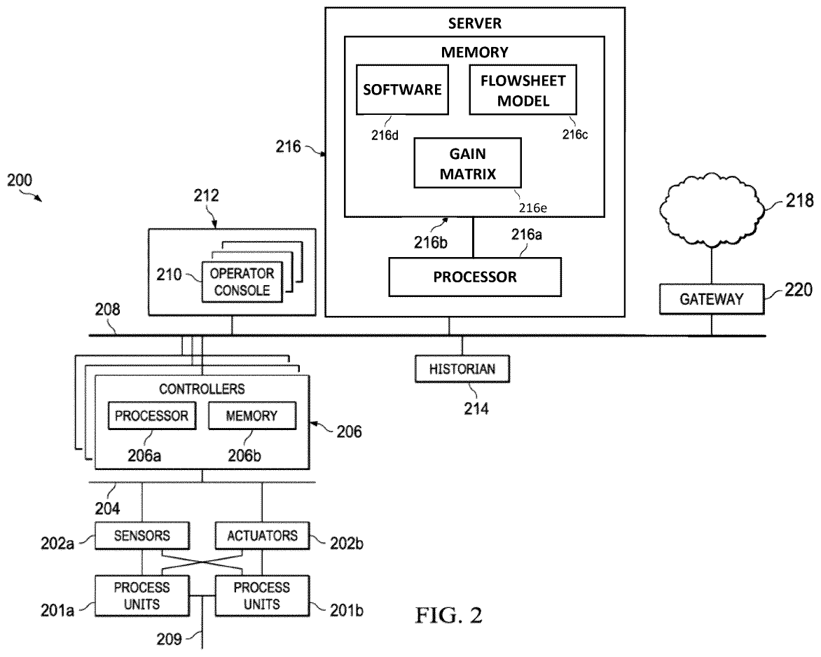

FIG. 2 illustrates an example industrial process control and automation system 200 that can benefit from disclosed aspects including the gain matrix having gains derived from analytic gains of models of process units or objects in an industrial plant (or process system). As shown in FIG. 2, system 200 includes various components that facilitate production or processing of at least one product or other tangible material. For instance, the system 200 can be used to facilitate control over components in one or multiple industrial plants. Each plant represents one or more processing facilities (or one or more portions thereof), such as one or more manufacturing facilities for producing at least one product or other tangible material. In general, each plant may implement one or more industrial processes and can individually or collectively be referred to as a process system, process unit or object. A process system generally represents any system or portion thereof configured to process one or more products or other materials in some manner.

The system 200 includes field devices comprising one or more sensors 202a and one or more actuators 202b that are coupled between controllers 206 and the processing equipment, shown in simplified form as process unit 201a coupled by piping 209 to process unit 201b. The sensors 202a and actuators 202b represent components in a process system that may perform any of a wide variety of functions. For example, the sensors 202a can measure a wide variety of characteristics in the process system, such as flow, pressure, or temperature. Also, the actuators 202b can alter a wide variety of characteristics in the process system, such as valve openings. Each of the sensors 202a includes any suitable structure for measuring one or more characteristics in a process system. Each of the actuators 202b includes any suitable structure for operating on or affecting one or more conditions in a process system.

At least one network 204 is shown providing a coupling between the controllers 206 and the sensors 202a and actuators 202b. The network 204 facilitates interaction with the sensors 202a and actuators 202b. For example, the network 204 can transport measurement data from the sensors 202a to the controllers 206 and provide control signals from the controllers 206 to the actuators 202b. The network 204 can represent any suitable network or combination of networks. As particular examples, the network 204 can represent at least one Ethernet network (such as one supporting a FOUNDATION FIELDBUS protocol), electrical signal network (such as a HART network), pneumatic control signal network, or any other or additional type(s) of network(s).

The system 200 also comprises various process controllers 206 generally configured in multiple Purdue model levels that may be present at all levels besides level 0, which only includes the field devices (sensors and actuators) and the processing equipment. Each process controller comprises a processor 206a coupled to a memory 206b. The process controllers 206 can be used in the system 200 to perform various functions in order to control one or more industrial processes (e.g., a process system, process unit, or object).

For example, a first set of process controllers 206 corresponding to level 1 in the Purdue model may refer to smart transmitters or smart flow controllers, where the control logic is embedded in these controller devices. Level 1 controllers do not implement Model Predictive Control (MPC). Level 2 generally refers to a distributed control system (DCS) controller, such as the C300 controller from Honeywell International. These level 2 controllers can also include more advanced strategies including machine level control built into the C300 controller, or another similar controller. Level 3 is generally reserved for controllers implemented by the server 216. These controllers interact with the other level (1, 2 and 4) controllers. MPC control can be implemented by controllers at level 2, but is generally implemented at level 3 and level 4. It is noted that not all control systems implement level 1, where the sensors and actuators (level 0) can be directly linked to a level 2 controller without any smart device in level 1. The C300 controller provides basic “loop” control as well as more advanced regulatory control schemes (including machine level control).

The level 1 controllers in the case of smart devices, or level 2 controllers such as the C300 controller, may use measurements from one or more sensors 202a to control the operation of one or more actuators 202b. The level 2 process controllers 206 can be used to optimize the control logic or other operations performed by the level 1 process controllers. For example, the machine-level controllers, such as DCS controllers, at Purdue level 2 can log information collected or generated by process controllers 206 that are on level 1, such as measurement data from the sensors 202a or control signals for the actuators 202b

A third set of controllers implemented by the server 216 corresponding to level 3 in the Purdue model, known as unit-level controllers which generally perform MPC control, can be used to perform additional functions. The process controllers 206 and controllers implemented by the server 216 can collectively therefore support a combination of approaches, such as regulatory control, advanced regulatory control, supervisory control, and advanced process control. In one arrangement, the third set of controllers implemented by the server 216 comprises an upper-tier controller corresponding to level 4 in the Purdue model, which generally also performs MPC control, also known as a plant-level controller (including the SWO), coupled to a lower-tier controller corresponding to level 3 in the Purdue model.

The hybrid MPC simulation model (flowsheet model) generally resides in a memory (shown as flowsheet model 216c and associated gain matrix 216e stored in memory 216b as shown in FIG. 2) associated with the upper-tier controller implemented by the server 216, wherein the upper-tier controller uses the flowsheet model to predict movements in the process participates in controlling the plant, and interacting with the flowsheet model to optimize overall economics of the plant including sending an output from the flowsheet model as setpoint targets to the lower-tier controller. The lower-tier controller uses the setpoint targets for diverting the raw material or the intermediate material in the piping network.

Each process controller 206, and the controller(s) implemented by the server 216, generally includes any suitable structure for controlling one or more aspects of an industrial process. At least some of the process controllers 206, and process controllers implemented by the server 216 could, for example, represent proportional-integral-derivative (PID) controllers or multivariable controllers, such as controllers implementing MPC or other advanced predictive control (APC). As a particular example, each process controller can represent a computing device running a real-time operating system, a WINDOWS operating system, or other operating system.

At least one of the process controllers 206 shown in FIG. 2 could denote a model-based process controller that operates using one or more process models. For example, each of these process controllers 206 can operate using one or more process models, including a disclosed hybrid MPC simulation (flowsheet) model, to determine, based on measurements from one or more sensors 202a, how to adjust one or more actuators 202b. In some embodiments, each model associates one or more MVs or DVs (often referred to as independent variables) with one or more CV s (often referred to as dependent variables). Each of these process controllers 206 could use an objective function to identify how to adjust its manipulated variables in order to push its CV s to the most attractive set of constraints.

At least one network 208 couples the process controllers 206 and other devices in the system 200. The network 208 facilitates the transport of information between two components. The network 208 can represent any suitable network or combination of networks. As particular examples, the network 208 can represent at least one Ethernet network.

Operator access to and interaction with the process controllers 206 and other components of the system 200 including the server 216 can occur via various operator consoles 210. Each operator console 210 can be used to provide information to an operator and receive information from an operator. For example, each operator console 210 can provide information identifying a current state of an industrial process to the operator, such as values of various process variables and warnings, alarms, or other states associated with the industrial process. Each operator console 210 can also receive information affecting how the industrial process is controlled, such as by receiving setpoints or control modes for process variables controlled by the process controllers 206 or process controller implemented by the server 216, or other information that alters or affects how the process controllers control the industrial process. Each operator console 210 includes any suitable structure for displaying information to and interacting with an operator. For example, each operator console 210 could represent a computing device running a WINDOWS operating system or other operating system.

Multiple operator consoles 210 can be grouped together and used in one or more control rooms 212. Each control room 212 could include any number of operator consoles 210 in any suitable arrangement. In some embodiments, multiple control rooms 212 can be used to control an industrial plant, such as when each control room 212 contains operator consoles 210 used to manage a discrete part of the industrial plant.

The system 200 may optionally include at least one data historian 214, and generally includes at least one server 216. The server 216 is generally in level 3 or 4 in the Purdue model. The server 216 includes a computing device shown as a processor 216a coupled to a memory 216b that stores a disclosed hybrid MPC simulation (flowsheet) model 216c. The memory generally comprises non-transitory computer-readable medium. The processor 216a can comprise a digital signal processor (DSP), a microcontroller, an application specific integrated circuit (ASIC), a general processor, or any other combination of one or more integrated processing devices. Disclosed software for generating a disclosed hybrid MPC simulation (flowsheet) model 216c also generally resides in one or more servers 216, shown as software 216d. The MPC controller utilizing the hybrid MPC simulation (flowsheet) model 216c gathers measurement information from the process controllers 206, including other APC controllers, to adjust the dynamic portion of the hybrid model, synchronizing it to the process conditions. Once synchronized, the hybrid MPC simulation (flowsheet) model generates the control structures necessary to control and optimize operations of the whole plant.

The data historian 214 represents a component that stores various information about the system 200. The data historian 214 can, for instance, store information that is generated by the various process controllers 206 during the control of one or more industrial processes. The data historian 214 includes any suitable structure for storing and facilitating retrieval of information. Although shown as a single component here, the data historian 214 can be located elsewhere in the system 200, such as in the cloud, or multiple data historians can be distributed in different locations in the system 200.

The server's 216 processor 216a executes applications for users of the operator consoles 210 or other applications. The applications can be used to support various functions for the operator consoles 210, the process controllers 206, or other components of the system 200. Each server 216 can represent a computing device running a WINDOWS operating system or other operating system. Note that while shown as being local within the system 200, the functionality of the server 216 can be remote from the system 200. For instance, the functionality of the server 216 can be implemented in a computing cloud 218, or in a remote server communicatively coupled to the system 200 via a gateway 220.

Although FIG. 2 illustrates one example of an industrial process control and automation system, various changes may be made to FIG. 2. For example, the system 200 can include any number of sensors, actuators, controllers, networks, operator consoles, control rooms, historians, servers, and other components.

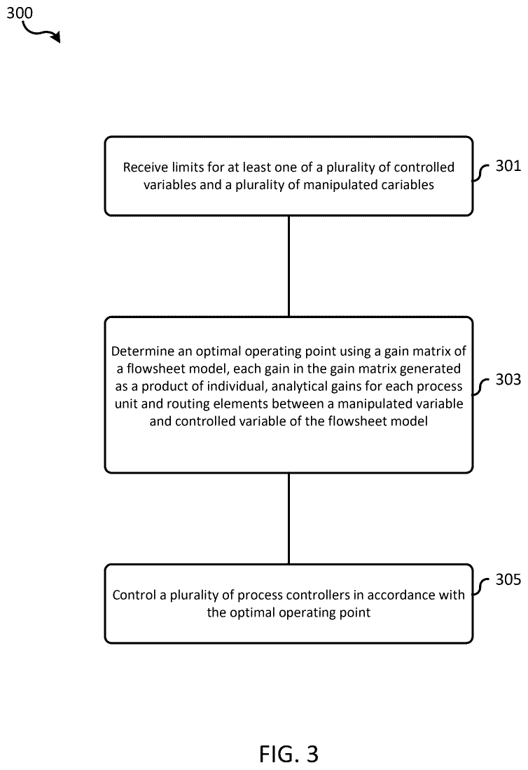

FIG. 3 is a flow chart of a process 300 for plant-wide optimization for use in an industrial plant. To run the optimization process at least two things are set: First, a product mix is selected based on which of the products that we are making are the most valuable. This is then tied into the optimization algorithm of the SWO. The objective is to optimize the plant to produce the most valuable products.

Production is often limited by fixed fuel contracts in various markets. This defines the minimum production for the various products at the refinery. If refinery capacity exceeds the minimum, surplus can be sold on the open market at market rates. The planning department tries to determine what the surplus will sell for and consequently sets the value of the surplus to be used in SWO. Depending on the relative values of the products, the SWO will favor one product over another and push production in that direction. The plant operator is more concerned that the units under control are operating correctly and moving in the expected direction. If there is a problem, the operator must take corrective action to keep the plant safe. However, the plant operator generally allows the unit controller to handle plant upsets but monitors its progress in case intervention is required. One way the plant operator imposes direction on the controller is to adjust the operating limits. These limits are also passed to the SWO. Consequently, the SWO takes economic forecasts from planning department and operating information from the controllers to come up with the economical way to produce products. The result of the SWO are targets sent back to the unit controller to shift production in the correct path.

At block 301, the operator of the plant sets the limits associated with the process units; specifically, limits associated with the controlled variables (CVs) and manipulated variables (MVs) of the plant. Generally, the operator sets some guardrails between high and low limits for the appropriate variables. The operator may move the limits based on operation constraints, but the operator is primarily looking at the limits.

In the system of FIG. 2, the limits are provided by an operator at one of consoles 210 and fed to the SWO (software part of software 216d) running on processor 216a of server 216. At block 303, process 300 determines an optimal operating point using a gain matrix of a flowsheet model, e.g. gain matrix 216c of flowsheet model 216c of server 216. As described above, each gain in the gain matrix is generated as a product of individual, analytical gains for each process unit or routing elements of the plant between the manipulated variable and controlled variable of the flowsheet model. Based on the determined optimal operating point, process 300 controls a plurality of controllers, such as controllers 206 of system 200 of FIG. 2.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory or other non-transitory computer readable medium. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs) or Field Programmable Gate Arrays (FGPAs).

### EXAMPLE EMBODIMENTS

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

Example 1 includes a plant-wide optimization system, comprising: a user interface configured to receive limits for at least one of a plurality of controlled variables and a plurality of manipulated variables for a plant; at least one processor; a non-transitory storage medium that stores an optimization program, and a flowsheet model, the flowsheet model having a gain matrix; wherein the flowsheet model includes a plurality of models that represent a plurality of process units or routing elements in the plant, the plant comprising at least one process controller coupled to field devices of the plurality of process units, wherein each of the plurality of process units comprise equipment for converting a raw material or an intermediate material into another material; wherein the plurality of models are interconnected in the flowsheet model to create a plant-wide model with a plurality of paths between a plurality of inlets of the plant and a plurality of outlets; wherein the flowsheet model includes the plurality of manipulated variables and the plurality of controlled variables, each associated with one or more of the plurality of process units or routing elements; wherein each gain in the gain matrix relates a change in one of the plurality of manipulated variables to a corresponding change in one of the plurality of controlled variables, wherein each gain is generated as a product of individual, analytical gains for each process unit and routing element between the one of the plurality of manipulated variables and the one of the plurality of controlled variables in the flowsheet model; and wherein the optimization program, when executed by the at least one processor, causes the at least one processor to perform a method including: receiving the limits for the at least one of the plurality of controlled variables and the plurality of manipulated variables from the user interface; determining an optimal operating point using the gain matrix of the flowsheet model for one or more of the plurality of manipulated variables using the received limits; and causing the at least one process controller to control the plurality of process units in accordance with the optimal operating point for the one or more of the plurality of manipulated variables.

Example 2 includes the plant-wide optimization system of example 1, wherein the plurality of models includes a model of a splitter configured to receive one inlet stream, and configured to output one outlet swing stream and at least one outlet non-swing stream; wherein the one inlet stream receives an inlet flow; wherein the one outlet swing stream provides a variable outlet flow which varies with the inlet flow; wherein each outlet non-swing stream provides an invariant outlet flow which is invariant to changes in the inlet flow; wherein a first gain for the model of the splitter is a change in the variable outlet flow of the one outlet swing stream divided by a change in the inlet flow, wherein the first gain is set to one; and wherein a second gain for the model of the splitter equals a change in the invariant outlet flow of the at least one outlet non-swing stream divided by the change in the inlet flow, wherein the second gain is set to zero.

Example 3 includes the plant-wide optimization system of any of examples 1 or 2, wherein the plurality of models includes a model of a junction configured to receive at least two inlet streams, combine the at least two inlet streams, and output one outlet stream; wherein each inlet stream receives a unique inlet flow and has at least one property; wherein the one outlet stream provides a variable outlet flow which is equal to a sum of each unique inlet flow; wherein the one outlet stream has the at least one property; wherein each of the at least one property of the one outlet stream, equals a flow weighted average of a property of each of the at least two inlet streams; wherein a first gain of each outlet stream equals one and is a change in the variable outlet flow divided by a change in one unique inlet flow; wherein a second gain equals a difference between a unique property of a unique inlet flow and the unique property of an outlet stream flow, divided by the variable outlet flow; and wherein a third gain, between an outlet property and an inlet property, equals a ratio of the inlet flow to the outlet flow.

Example 4 includes the plant-wide optimization system of any of examples 1 through 3, wherein the plurality of models includes a model of a selector configured to receive one inlet stream, and configured to output one outlet diversion stream and at least one outlet non-diversion stream; wherein the one inlet stream receives an inlet flow; wherein the one outlet diversion stream provides a variable outlet flow which varies with the inlet flow; wherein each outlet non-diversion stream provides no material outlet flow; wherein a first gain for the model of the selector is a change in the variable outlet flow of the one outlet diversion stream divided by a change in the inlet flow, wherein the first gain is set to one; and wherein a second gain for the model of the selector equals a change in the outlet flow of the at least one outlet non-diversion stream divided by the change in the inlet flow, wherein the second gain is set to zero.

Example 5 includes the plant-wide optimization system of any of examples 1 to 5, wherein the plurality of models includes a user-supplied model for a blender that employs a nonlinear mixing rule, wherein the user-supplied model includes property gains, wherein a first property gain relates an outlet property to an inlet property and a second property gain relates an output property to an inlet flow.

Example 6 includes the plant-wide optimization system of any of examples 1 to 5, wherein the plurality of models includes a model of a tank configured to receive one or more inlet streams, each inlet stream having a flow with one or more properties, a volume of material in the tank with one or more properties, and an outlet flow with the same properties as the volume of material in the tank; the model further including a plurality of gains, wherein the plurality of gains include one or more of: a first gain that represents a change in the volume of material in the tank to the inlet flow; a second gain that represents a change in the volume of the material in the tank to the outlet flow; a third gain that represents a change in one of the one or properties of the material in the tank to the inlet flow; a fourth gain that represents a change in one of the one or more properties of the material in the tank to a property of the inlet flow; and a fifth gain represents a change in one of the one or more properties of the outlet flow to one of the one or more properties of the material in the tank.

Example 7 includes the plant-wide optimization system of any of examples 1 to 6, wherein the plurality of models includes a model of a Tear that represents a recycle stream in a plant, wherein an outlet stream of a downstream model is returned to an inlet stream of an upstream model to recycle the outlet stream of the downstream model.

Example 8 includes the plant-wide optimization system of any of examples 1 to 7, wherein each model of the plurality of models includes one or more of a first gain, a second gain and a third gain; wherein: the first gain equals a ratio of an outlet flow to an inlet flow; the second gain equals a ratio of a property of an outlet flow divided by a property of an inlet flow; and the third gain equals a ratio of a property of an outlet flow and an inlet flow.

Example 9 includes a method for plant-wide optimization, the method comprising: receiving limits for at least one of a plurality of controlled variables and a plurality of manipulated variables for a plant at a user interface; determining an optimal operating point using a gain matrix of a flowsheet model for one or more of the plurality of manipulated variables using the limits for the at least one of the plurality of controlled variables and the plurality of manipulated variables; wherein the flowsheet model includes a plurality of models that represent a plurality of process units or routing elements in the plant, the plant comprising at least one process controller coupled to field devices of the plurality of process units, wherein each of the plurality of process units comprise equipment for converting a raw material or an intermediate material into another material; wherein the plurality of models are interconnected in the flowsheet model to create a plant-wide model with a plurality of paths between a plurality of inlets of the plant and a plurality of outlets; wherein the flowsheet model includes the plurality of manipulated variables and the plurality of controlled variables, each associated with one or more of the plurality of process units or routing elements; wherein each gain in the gain matrix relates a change in one of the plurality of manipulated variables to a corresponding change in one of the plurality of controlled variables, wherein each gain is generated as a product of individual, analytical gains for each process unit and routing element between the one of the plurality of manipulated variables and the one of the plurality of controlled variables in the flowsheet model; and causing the at least one process controller to control the plurality of process units in accordance with the optimal operating point for the one or more of the plurality of manipulated variables.

Example 10 includes the method of example 9, wherein the plurality of models includes a model of a splitter configured to receive one inlet stream, and configured to output one outlet swing stream and at least one outlet non-swing stream; wherein the one inlet stream receives an inlet flow; wherein the one outlet swing stream provides a variable outlet flow which varies with the inlet flow; wherein each outlet non-swing stream provides an invariant outlet flow which is invariant to changes in the inlet flow; wherein a first gain for the model of the splitter is a change in the variable outlet flow of the one outlet swing stream divided by a change in the inlet flow, wherein the first gain is set to one; and wherein a second gain for the model of the splitter equals a change in the invariant outlet flow of the at least one outlet non-swing stream divided by the change in the inlet flow, wherein the second gain is set to zero.

Example 11 includes the method of any of examples 9 and 10, wherein the plurality of models includes a model of a junction configured to receive at least two inlet streams, combine the at least two inlet streams, and output one outlet stream; wherein each inlet stream receives a unique inlet flow and has at least one property; wherein the one outlet stream provides a variable outlet flow which is equal to a sum of each unique inlet flow; wherein the one outlet stream has the at least one property; wherein each of the at least one property of the one outlet stream, equals a flow weighted average of a property of each of the at least two inlet streams; wherein a first gain of each outlet stream equals one and is a change in the variable outlet flow divided by a change in one unique inlet flow; wherein a second gain equals a difference between a unique property of a unique inlet flow and the unique property of an outlet stream flow, divided by the variable outlet flow; and wherein a third gain, between an outlet property and an inlet property, equals a ratio of the inlet flow to the outlet flow.

Example 12 includes the method of any of examples 9 to 11, wherein the plurality of models includes a model of a selector configured to receive one inlet stream, and configured to output one outlet diversion stream and at least one outlet non-diversion stream; wherein the one inlet stream receives an inlet flow; wherein the one outlet diversion stream provides a variable outlet flow which varies with the inlet flow; wherein each outlet non-diversion stream provides no material outlet flow; wherein a first gain for the model of the selector is a change in the variable outlet flow of the one outlet diversion stream divided by a change in the inlet flow, wherein the first gain is set to one; and wherein a second gain for the model of the selector equals a change in the outlet flow of the at least one outlet non-diversion stream divided by the change in the inlet flow, wherein the second gain is set to zero.

Example 13 includes the method of any of examples 9 to 12, wherein the plurality of models includes a user-supplied model for a blender that employs a nonlinear mixing rule, wherein the user-supplied model includes property gains, wherein a first property gain relates an outlet property to an inlet property and a second property gain relates an output property to an inlet flow.

Example 14 includes the method of any of examples 9 to 13, wherein the plurality of models includes a model of a tank configured to receive one or more inlet streams, each inlet stream having a flow with one or more properties, a volume of material in the tank with one or more properties, and an outlet flow with the same properties as the volume of material in the tank; the model further including a plurality of gains, wherein the plurality of gains include one or more of: a first gain that represents a change in the volume of material in the tank to the inlet flow; a second gain that represents a change in the volume of the material in the tank to the outlet flow; a third gain that represents a change in one of the one or more properties of the material in the tank to the inlet flow; a fourth gain that represents a change in one of the one or more properties of the material in the tank to a property of the inlet flow; and a fifth gain represents a change in one of the one or more properties of the outlet flow to one of the one or more properties of the material in the tank.

Example 15 includes the method of any of examples 9 to 14, wherein the plurality of models includes a model of a tear that represents a recycle stream in a plant, wherein an outlet stream of a downstream model is returned to an inlet stream of an upstream model to recycle the outlet stream of the downstream model.

Example 16 includes the method of any of examples 9 to 15, wherein each model of the plurality of models includes one or more of a first gain, a second gain and a third gain; wherein: the first gain equals a ratio of an outlet flow to an inlet flow; the second gain equals a ratio of a property of an outlet flow divided by a property of an inlet flow; and the third gain equals a ratio of a property of an outlet flow and an inlet flow.

Example 17 includes a non-transitory computer-readable medium including a set of instructions that, when executed by at least one processor, cause the at least one processor to perform the method including: receiving limits for at least one of a plurality of controlled variables and a plurality of manipulated variables for a plant at a user interface; determining an optimal operating point using a gain matrix of a flowsheet model for one or more of the plurality of manipulated variables using the limits for the at least one of the plurality of controlled variables; wherein the flowsheet model includes a plurality of models that represent a plurality of process units or routing elements in the plant, the plant comprising at least one process controller coupled to field devices of the plurality of process units, wherein each of the plurality of process units comprise equipment for converting a raw material or an intermediate material into another material; wherein the plurality of models are interconnected in the flowsheet model to create a plant-wide model with a plurality of paths between a plurality of inlets of the plant and a plurality of outlets; wherein the flowsheet model includes the plurality of manipulated variables and the plurality of controlled variables, each associated with one or more of the plurality of process units or routing elements; wherein each gain in the gain matrix relates a change in one of the plurality of manipulated variables to a corresponding change in one of the plurality of controlled variables, wherein each gain is generated as a product of individual, analytical gains for each process unit and routing element between the one of the plurality of manipulated variables and the one of the plurality of controlled variables in the flowsheet model; and controlling the plurality of process units in accordance with the optimal operating point for the one or more of the plurality of manipulated variables.

Example 18 includes the non-transitory computer readable medium of example 17, wherein each model of the plurality of models includes one or more of a first gain, a second gain and a third gain; wherein: the first gain equals a ratio of an outlet flow to an inlet flow; the second gain equals a ratio of a property of an outlet flow divided by a property of an inlet flow; and the third gain equals a ratio of a property of an outlet flow and an inlet flow.

Example 19 includes the non-transitory computer readable medium of any of examples 17 and 18, wherein the flowsheet model includes models for one or more of a tank, a tear, a blender, a selector, a junction, and a splitter.

Example 20 includes the non-transitory computer readable medium of example 19, wherein the model for the blender comprises a user-supplied model that employs a nonlinear mixing rule, wherein the user-supplied model includes property gains, wherein a first property gain relates an outlet property to an inlet property and a second property gain relates an output property to an inlet flow.

What is claimed is:

1. A plant-wide optimization system, comprising:
a user interface configured to receive limits for at least one of a plurality of controlled variables and a plurality of manipulated variables for a plant;
at least one processor;
a non-transitory storage medium that stores an optimization program, and a flowsheet model, the flowsheet model having a gain matrix;
wherein the flowsheet model includes a plurality of models that represent a plurality of process units or routing elements in the plant, the plant comprising at least one process controller coupled to field devices of the plurality of process units, wherein each of the plurality of process units comprise equipment for converting a raw material or an intermediate material into another material;
wherein the plurality of models are interconnected in the flowsheet model to create a plant-wide model with a plurality of paths between a plurality of inlets of the plant and a plurality of outlets;
wherein the flowsheet model includes the plurality of manipulated variables and the plurality of controlled variables, each associated with one or more of the plurality of process units or routing elements;
wherein each gain in the gain matrix relates a change in one of the plurality of manipulated variables to a corresponding change in one of the plurality of controlled variables, wherein each gain is generated as a product of individual, analytical gains for each process unit and routing element between the one of the plurality of manipulated variables and the one of the plurality of controlled variables in the flowsheet model; and
wherein the optimization program, when executed by the at least one processor, causes the at least one processor to perform a method including:
receiving the limits for the at least one of the plurality of controlled variables and the plurality of manipulated variables from the user interface;
determining an optimal operating point using the gain matrix of the flowsheet model for one or more of the plurality of manipulated variables using the received limits; and
causing the at least one process controller to control the plurality of process units in accordance with the optimal operating point for the one or more of the plurality of manipulated variables.

2. The plant-wide optimization system of claim 1, wherein the plurality of models includes a model of a splitter configured to receive one inlet stream, and configured to output one outlet swing stream and at least one outlet non-swing stream;
wherein the one inlet stream receives an inlet flow;
wherein the one outlet swing stream provides a variable outlet flow which varies with the inlet flow;
wherein each outlet non-swing stream provides an invariant outlet flow which is invariant to changes in the inlet flow;
wherein a first gain for the model of the splitter is a change in the variable outlet flow of the one outlet swing stream divided by a change in the inlet flow, wherein the first gain is set to one; and
wherein a second gain for the model of the splitter equals a change in the invariant outlet flow of the at least one outlet non-swing stream divided by the change in the inlet flow, wherein the second gain is set to zero.

3. The plant-wide optimization system of claim 1, wherein the plurality of models includes a model of a junction configured to receive at least two inlet streams, combine the at least two inlet streams, and output one outlet stream;
wherein each inlet stream receives a unique inlet flow and has at least one property;
wherein the one outlet stream provides a variable outlet flow which is equal to a sum of each unique inlet flow;
wherein the one outlet stream has the at least one property;
wherein each of the at least one property of the one outlet stream, equals a flow weighted average of a property of each of the at least two inlet streams;
wherein a first gain of each outlet stream equals one and is a change in the variable outlet flow divided by a change in one unique inlet flow;
wherein a second gain equals a difference between a unique property of a unique inlet flow and the unique property of an outlet stream flow, divided by the variable outlet flow; and
wherein a third gain, between an outlet property and an inlet property, equals a ratio of the inlet flow to the outlet flow.

4. The plant-wide optimization system of claim 1, wherein the plurality of models includes a model of a selector configured to receive one inlet stream, and configured to output one outlet diversion stream and at least one outlet non-diversion stream;
wherein the one inlet stream receives an inlet flow;
wherein the one outlet diversion stream provides a variable outlet flow which varies with the inlet flow;
wherein each outlet non-diversion stream provides no material outlet flow;
wherein a first gain for the model of the selector is a change in the variable outlet flow of the one outlet diversion stream divided by a change in the inlet flow, wherein the first gain is set to one; and
wherein a second gain for the model of the selector equals a change in the outlet flow of the at least one outlet non-diversion stream divided by the change in the inlet flow, wherein the second gain is set to zero.

5. The plant-wide optimization system of claim 1, wherein the plurality of models includes a user-supplied model for a blender that employs a nonlinear mixing rule, wherein the user-supplied model includes property gains, wherein a first property gain relates an outlet property to an inlet property and a second property gain relates an output property to an inlet flow.

6. The plant-wide optimization system of claim 1, wherein the plurality of models includes a model of a tank configured to receive one or more inlet streams, each inlet stream having a flow with one or more properties, a volume of material in the tank with one or more properties, and an outlet flow with the same properties as the volume of material in the tank;
the model further including a plurality of gains, wherein the plurality of gains include one or more of:
a first gain that represents a change in the volume of material in the tank to the inlet flow;
a second gain that represents a change in the volume of the material in the tank to the outlet flow;
a third gain that represents a change in one of the one or properties of the material in the tank to the inlet flow;
a fourth gain that represents a change in one of the one or more properties of the material in the tank to a property of the inlet flow; and
a fifth gain represents a change in one of the one or more properties of the outlet flow to one of the one or more properties of the material in the tank.

7. The plant-wide optimization system of claim 1, wherein the plurality of models includes a model of a Tear that represents a recycle stream in a plant, wherein an outlet stream of a downstream model is returned to an inlet stream of an upstream model to recycle the outlet stream of the downstream model.

8. The plant-wide optimization system of claim 1, wherein each model of the plurality of models includes one or more of a first gain, a second gain and a third gain;
wherein:
the first gain equals a ratio of an outlet flow to an inlet flow;
the second gain equals a ratio of a property of an outlet flow divided by a property of an inlet flow; and
the third gain equals a ratio of a property of an outlet flow and an inlet flow.

9. A method for plant-wide optimization, the method comprising:
receiving limits for at least one of a plurality of controlled variables and a plurality of manipulated variables for a plant at a user interface;
determining an optimal operating point using a gain matrix of a flowsheet model for one or more of the plurality of manipulated variables using the limits for the at least one of the plurality of controlled variables and the plurality of manipulated variables;
wherein the flowsheet model includes a plurality of models that represent a plurality of process units or routing elements in the plant, the plant comprising at least one process controller coupled to field devices of the plurality of process units, wherein each of the plurality of process units comprise equipment for converting a raw material or an intermediate material into another material;
wherein the plurality of models are interconnected in the flowsheet model to create a plant-wide model with a plurality of paths between a plurality of inlets of the plant and a plurality of outlets;
wherein the flowsheet model includes the plurality of manipulated variables and the plurality of controlled variables, each associated with one or more of the plurality of process units or routing elements;
wherein each gain in the gain matrix relates a change in one of the plurality of manipulated variables to a corresponding change in one of the plurality of controlled variables, wherein each gain is generated as a product of individual, analytical gains for each process unit and routing element between the one of the plurality of manipulated variables and the one of the plurality of controlled variables in the flowsheet model; and
causing the at least one process controller to control the plurality of process units in accordance with the optimal operating point for the one or more of the plurality of manipulated variables.

10. The method of claim 9, wherein the plurality of models includes a model of a splitter configured to receive one inlet stream, and configured to output one outlet swing stream and at least one outlet non-swing stream;
wherein the one inlet stream receives an inlet flow;
wherein the one outlet swing stream provides a variable outlet flow which varies with the inlet flow;
wherein each outlet non-swing stream provides an invariant outlet flow which is invariant to changes in the inlet flow;
wherein a first gain for the model of the splitter is a change in the variable outlet flow of the one outlet swing stream divided by a change in the inlet flow, wherein the first gain is set to one; and
wherein a second gain for the model of the splitter equals a change in the invariant outlet flow of the at least one outlet non-swing stream divided by the change in the inlet flow, wherein the second gain is set to zero.

11. The method of claim 9, wherein the plurality of models includes a model of a junction configured to receive at least two inlet streams, combine the at least two inlet streams, and output one outlet stream;
wherein each inlet stream receives a unique inlet flow and has at least one property;
wherein the one outlet stream provides a variable outlet flow which is equal to a sum of each unique inlet flow;
wherein the one outlet stream has the at least one property;
wherein each of the at least one property of the one outlet stream, equals a flow weighted average of a property of each of the at least two inlet streams;
wherein a first gain of each outlet stream equals one and is a change in the variable outlet flow divided by a change in one unique inlet flow;
wherein a second gain equals a difference between a unique property of a unique inlet flow and the unique property of an outlet stream flow, divided by the variable outlet flow; and
wherein a third gain, between an outlet property and an inlet property, equals a ratio of the inlet flow to the outlet flow.

12. The method of claim 9, wherein the plurality of models includes a model of a selector configured to receive one inlet stream, and configured to output one outlet diversion stream and at least one outlet non-diversion stream;
wherein the one inlet stream receives an inlet flow;
wherein the one outlet diversion stream provides a variable outlet flow which varies with the inlet flow;
wherein each outlet non-diversion stream provides no material outlet flow;
wherein a first gain for the model of the selector is a change in the variable outlet flow of the one outlet diversion stream divided by a change in the inlet flow, wherein the first gain is set to one; and
wherein a second gain for the model of the selector equals a change in the outlet flow of the at least one outlet non-diversion stream divided by the change in the inlet flow, wherein the second gain is set to zero.

13. The method of claim 9, wherein the plurality of models includes a user-supplied model for a blender that employs a nonlinear mixing rule, wherein the user-supplied model includes property gains, wherein a first property gain relates an outlet property to an inlet property and a second property gain relates an output property to an inlet flow.

14. The method of claim 9, wherein the plurality of models includes a model of a tank configured to receive one or more inlet streams, each inlet stream having a flow with one or more properties, a volume of material in the tank with one or more properties, and an outlet flow with the same properties as the volume of material in the tank;
the model further including a plurality of gains, wherein the plurality of gains include one or more of:
a first gain that represents a change in the volume of material in the tank to the inlet flow;
a second gain that represents a change in the volume of the material in the tank to the outlet flow;
a third gain that represents a change in one of the one or more properties of the material in the tank to the inlet flow;
a fourth gain that represents a change in one of the one or more properties of the material in the tank to a property of the inlet flow; and
a fifth gain represents a change in one of the one or more properties of the outlet flow to one of the one or more properties of the material in the tank.

15. The method of claim 9, wherein the plurality of models includes a model of a tear that represents a recycle stream in a plant, wherein an outlet stream of a downstream model is returned to an inlet stream of an upstream model to recycle the outlet stream of the downstream model.

16. The method of claim 9, wherein each model of the plurality of models includes one or more of a first gain, a second gain and a third gain;
wherein:
the first gain equals a ratio of an outlet flow to an inlet flow;
the second gain equals a ratio of a property of an outlet flow divided by a property of an inlet flow; and
the third gain equals a ratio of a property of an outlet flow and an inlet flow.

17. A non-transitory computer-readable medium including a set of instructions that, when executed by at least one processor, cause the at least one processor to perform the method including:
receiving limits for at least one of a plurality of controlled variables and a plurality of manipulated variables for a plant at a user interface;
determining an optimal operating point using a gain matrix of a flowsheet model for one or more of the plurality of manipulated variables using the limits for the at least one of the plurality of controlled variables;
wherein the flowsheet model includes a plurality of models that represent a plurality of process units or routing elements in the plant, the plant comprising at least one process controller coupled to field devices of the plurality of process units, wherein each of the plurality of process units comprise equipment for converting a raw material or an intermediate material into another material;
wherein the plurality of models are interconnected in the flowsheet model to create a plant-wide model with a plurality of paths between a plurality of inlets of the plant and a plurality of outlets;
wherein the flowsheet model includes the plurality of manipulated variables and the plurality of controlled variables, each associated with one or more of the plurality of process units or routing elements;
wherein each gain in the gain matrix relates a change in one of the plurality of manipulated variables to a corresponding change in one of the plurality of controlled variables, wherein each gain is generated as a product of individual, analytical gains for each process unit and routing element between the one of the plurality of manipulated variables and the one of the plurality of controlled variables in the flowsheet model; and
controlling the plurality of process units in accordance with the optimal operating point for the one or more of the plurality of manipulated variables.

18. The non-transitory computer readable medium of claim 17, wherein each model of the plurality of models includes one or more of a first gain, a second gain and a third gain;
wherein:
the first gain equals a ratio of an outlet flow to an inlet flow;
the second gain equals a ratio of a property of an outlet flow divided by a property of an inlet flow; and
the third gain equals a ratio of a property of an outlet flow and an inlet flow.

19. The non-transitory computer readable medium of claim 17, wherein the flowsheet model includes models for one or more of a tank, a tear, a blender, a selector, a junction, and a splitter.

20. The non-transitory computer readable medium of claim 19, wherein the model for the blender comprises a user-supplied model that employs a nonlinear mixing rule, wherein the user-supplied model includes property gains, wherein a first property gain relates an outlet property to an inlet property and a second property gain relates an output property to an inlet flow.
